(19) United States
(12) Patent Application Publication
(10) Pub. No.: US 2019/0380463 A1
(43) Pub. Date: Dec. 19, 2019

(54) HAND HELD APPLIANCE

(71) Applicant: Dyson Technology Limited, Wiltshire (GB)

(72) Inventors: Ilidio Silvestre GUERREIRO, Bath (GB); Samuel William SAUNDERS, Swindon (GB); Edward Sebert Maurice SHELTON, Swindon (GB); Lolan NAICKER, Gloucester (GB)

(73) Assignee: Dyson Technology Limited, Wiltshire (GB)

(21) Appl. No.: 16/477,438

(22) PCT Filed: Jan. 12, 2017
(86) PCT No.: PCT/GB2017/050079

§ 371 Date: Jul. 11, 2019

(51) Int. Cl. A45D 1/00; A45D 2/00

(52) U.S. Cl. CPC A45D 1/00; A45D 20/12; A45D 2/001

(57) ABSTRACT

A hand held appliance including a fluid flow path extending between a fluid inlet and a fluid outlet and a ceramic heater within the fluid flow path wherein the fluid flow path is non-linear and the heater is non-linear. The appliance may include a housing wherein the housing houses the heater and encloses the fluid flow path, and wherein the housing is curved. The heater may be curved. The housing may include a straight section and a curved section and the heater is housed within the curved section. The heater may include at least one heating element comprising a flat ceramic plate and a conductive track. The heating element may be arcuate. The heating element may have a constant curvature.

### REFERENCE TO RELATED APPLICATIONS

This application is a national stage application under 35 USC 371 of International Application No. PCT/GB2017/050079, filed Jan. 12, 2017, the entire contents of which are incorporated herein by reference.

### FIELD OF THE INVENTION

This invention relates to a hand held appliance, and in particular a hand held appliance having a heater.

### BACKGROUND OF THE INVENTION

Hand held appliances such as hair care appliances and hot air blowers are known. Such appliances are provided with a heater to heat either fluid flowing through the appliance or a surface at which the appliance is directed. Most devices are either in the form of a pistol grip with a handle including switches and a body which houses components such as a fan unit and a heater. Another form is for a tubular housing such as found with hot styling devices. Thus, generally the option is to have fluid and/or heat blowing out of an end of a tubular housing and either to hold onto that housing or be provided with a handle orthogonal to the tubular housing.

This makes the appliance either bulky or sometimes difficult to use as the appliance can be long and/or heavy. A solution to this is two provide a curved form as this reduces the length and can remove some of the bulk. It is known to have a curved hair care appliance with a curved section and then to provide a fan unit in a straight section on one side and the heater in a straight section on the other side. This has the problem that in the curved section fluid can become turbulent resulting in pressure losses and the production of noise. This could be mitigated by turning vanes in the curved section but that adds weight and cost to the appliance. Thus, the inventors have combined the use of a curved hairdryer with the use of a curved ceramic heater so features of the heater can be used to turn and direct the fluid flowing through the curved section and heat this fluid at the same time. This makes the design smaller, quieter and the fluid flowing from the outlet of the appliance can be engineered to exit at any convenient angle regardless of the location of the fluid inlet.

### SUMMARY OF THE INVENTION

Thus, according to a first aspect, a hand held appliance comprises a fluid flow path extending between a fluid inlet and a fluid outlet and a ceramic heater within the fluid flow path wherein the fluid flow path is non-linear and the heater is non-linear.

Preferably, the appliance further comprises a housing wherein the housing houses the heater and encloses the fluid flow path, and wherein the housing is curved. In a preferred embodiment the heater is curved.

Thus, according to a second aspect, a hand held appliance comprises a housing, a fluid flow path extending between a fluid inlet and a fluid outlet and a ceramic heater within the fluid flow path wherein the housing houses the heater and encloses the fluid flow path, and wherein the housing is curved and the heater is curved.

Preferably, the housing comprises a straight section and a curved section and the heater is housed within the curved section.

In a preferred embodiment the heater comprises at least one heating element comprising a flat ceramic plate and a conductive track.

Preferably, the heating element is arcuate.

Thus, according to a third embodiment, a housing, a fluid flow path extending between a fluid inlet and a fluid outlet and a ceramic heater within the fluid flow path are provided wherein the housing houses the heater and encloses the fluid flow path, and wherein the housing is curved and the heater is curved.

In a preferred embodiment the heating element has a constant curvature.

Preferably, the heating element curves around an angle of 10° to 170°. In a preferred embodiment the heating element curves around an angle of 80° to 120°.

In a preferred embodiment the heater comprises a heating element and a plurality of fins extending away from the heating element wherein, the plurality of fins dissipate heat from the heating element into the fluid flow path.

Preferably, the heating element is an arcuate flat plate and the plurality of fins extend away from the heating element and are also arcuate.

In a preferred embodiment each one of the plurality of fins follows the same angle of curvature as the heating element.

Preferably, the heater comprises a heating element and a plurality of fins extending away from the heating element wherein, the plurality of fins direct flow of fluid flowing within the heater.

In a preferred embodiment, the plurality of fins comprise a channel extending between adjacent pairs of the plurality of fins and wherein each channel directs flow through the heater.

Preferably, each channel is defined by a surface of a pair of adjacent fins and a portion of a surface of the heating element and wherein, each channel dissipated thermal energy from the heating element into fluid flowing within the fluid flow path.

In a preferred embodiment the housing comprises a straight portion and a curved portion.

Preferably, within the straight portion, the housing houses a fan unit.

In a preferred embodiment, within the straight portion the housing comprises a handle.

Preferably, the appliance is a hair care appliance. It is preferred that the appliance is a hair dryer.

### BRIEF DESCRIPTION OF THE DRAWINGS

The invention will now be described with reference to the accompanying drawings, of which:

FIG. 1 shows a front view of an appliance according to aspects of the invention;

FIG. 2 shows a cross section along line C-C through the appliance of FIG. 1;

FIG. 3 shows schematically an isometric view of the appliance of FIG. 1;

FIG. 4 shows a front view of a further appliance according to aspects of the invention;

FIG. 5 shows a cross section along line L-L through the appliance of FIG. 4;

FIG. 6a shows a front view of part of a heater according to aspects of the invention;

FIG. 6b shows a side view of the heater of FIG. 6a;

FIG. 6c shows an isometric view of the heater of FIG. 6a;

FIG. 6d shows a cross section along lone A-A of FIG. 6a;

FIG. 7 shows a side view of a different heater;

FIG. 8a shows a front view of part of another heater according to aspects of the invention;

FIG. 8b shows a side view of the heater of FIG. 8a;

FIG. 8c shows an isometric view of the heater of FIG. 8a;

FIG. 8d shows an enlarged view of portion Z of FIG. 8c;

FIG. 9a shows a side view of another heater;

FIG. 9b shows a cross section along line F-F through the appliance of FIG. 9a;

FIG. 10a shows a front view of part of another heater according to aspects of the invention;

FIG. 10b shows an isometric view of the heater of FIG. 10a; and

FIG. 10c shows a cross section along line G-G through the appliance of FIG. 10a.

### DETAILED DESCRIPTION OF THE INVENTION

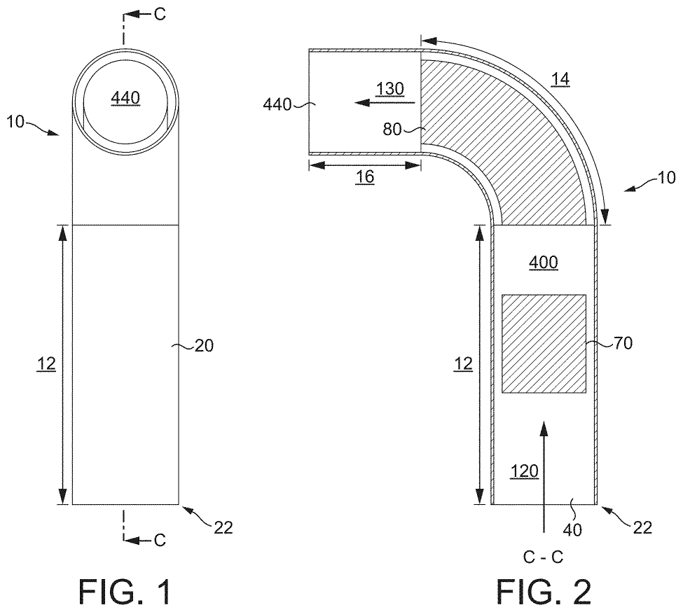

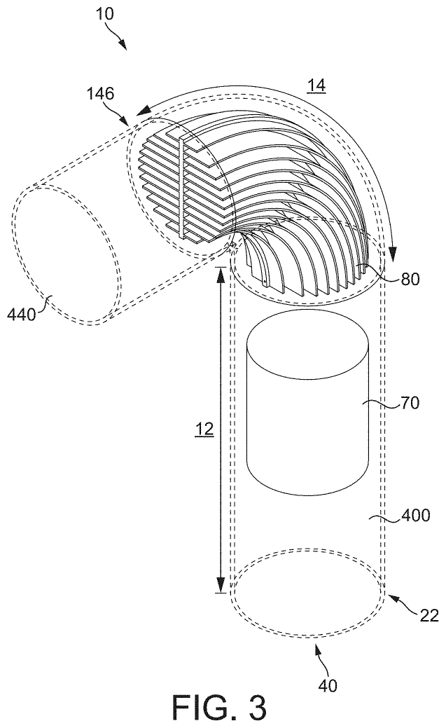

FIGS. 1, 2, and 3 show an appliance, in this case a hairdryer 10 having a curved outer profile. There a straight section 12 which includes a handle 20 and a curved section 14 which includes a heater 80. A fluid flow path 400 is provided through the appliance from a fluid inlet 40 which is provided at a first end 22 of the straight section 12 to a fluid outlet 440. The fluid outlet 440 is provided adjacent or downstream of the distal end 14b of the curved section 14 from the straight section 12. In this embodiment, there is a second straight section 16 provided downstream of the heater 80 or between the curved section 14 and the fluid outlet 440.

The fluid flow path 400 is non-linear and flows through the straight section 12 and the handle 20 in a first direction 120 and exits from the curved section 14 in a second direction 130. At the fluid outlet 440, the fluid flow path 400 has turned 90°, thus the first direction 120 is orthogonal to the second direction 130. However, this is just one example, different degrees of curvature can be used.

The hairdryer 10 can be considered to have an inlet plane extending across the first end 22 of the straight section 12 and an outlet plane extending across the fluid outlet 440 and the inlet plane and the outlet plane are non-parallel.

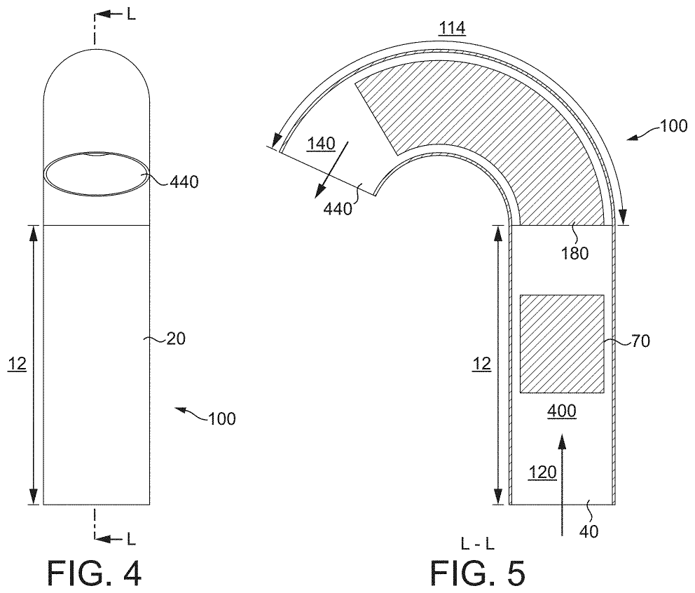

A second example of an appliance 100 is shown in FIGS. 4 and 5. In this embodiment, components illustrated and already described in relation to FIGS. 1 to 3 have like reference numerals. In this embodiment, the heater 180 extends further than 90°, thus the first direction 120 is not orthogonal to the section direction 140. The heater 180 extends in an arc of about 120°.

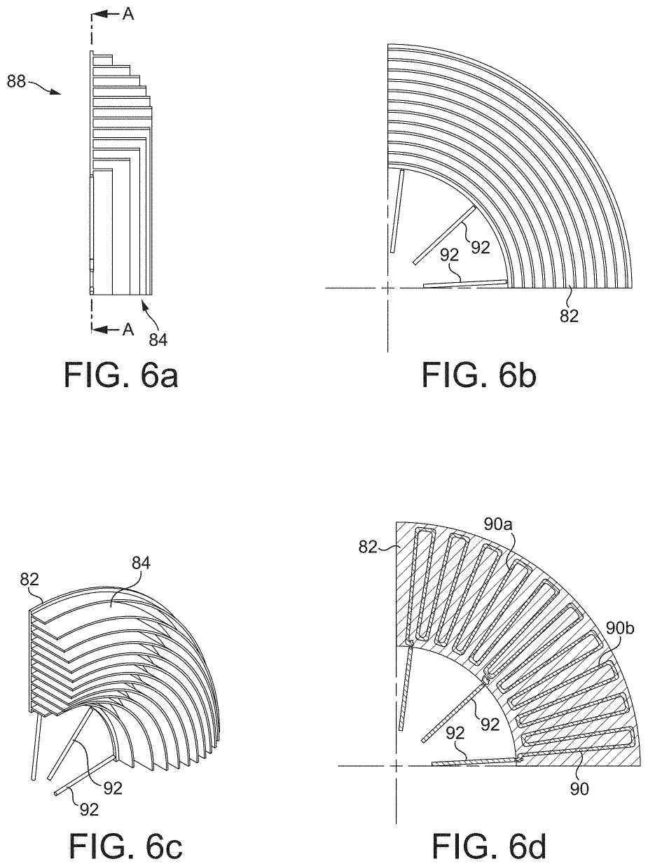

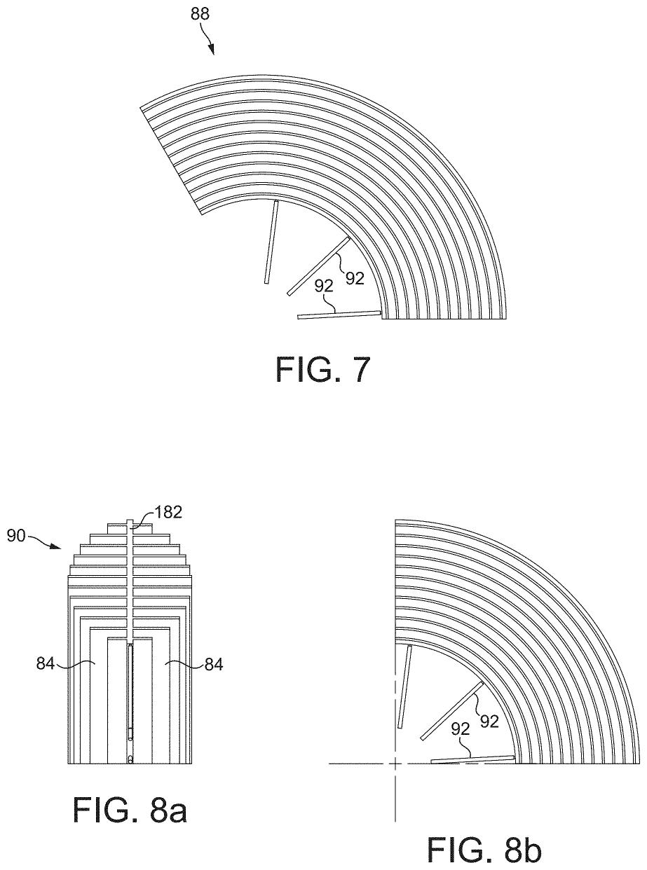

Referring now to FIGS. 6a to 6d and 7, the heater 80, 180 will be described in more detail. The heater 80, 180 comes in two parts which are subsequently bonded together. FIGS. 6a to 6c show one of the two parts. The other of the two parts tends to be a mirror image of the one shown. The heater 80, 180 comprises a heating element 88 formed from a flat ceramic plate 82 such as aluminium nitride which has a conductive track 90 typically screen printed onto the flat ceramic plate 82 when in its' green state. Heat is dissipated from the conductive track 90 via fins 84 which extend out from the flat ceramic plate 82 and into the fluid flow path 400. The conductive track 90 is electrically connected to a power source (not shown) via heater connection leads 92. In this example the heater includes two heater tracks 90a and 90b and there are three leads 92 as the two heater tracks 90a and 90b share either the live or the neutral connection.

The heaters 80, 180 are single sided unified heaters and there are a few ways of manufacturing them. In one example, the heating element 88 can be fired and then sintered fins 84 can be bonded to the sintered heating element 88 using a bonding paste such as a glass bonding paste. Alternatively, the fins 84 can be attached to the flat ceramic plate 82 in the green state and they can be co-fired as a single unit.

Once each part of the heater has been made the two parts are bonded together.

FIG. 7, shows the heater 180 having a 120° bend or turn whereas FIGS. 6a to 6d show the heater having a 90° bend or turn.

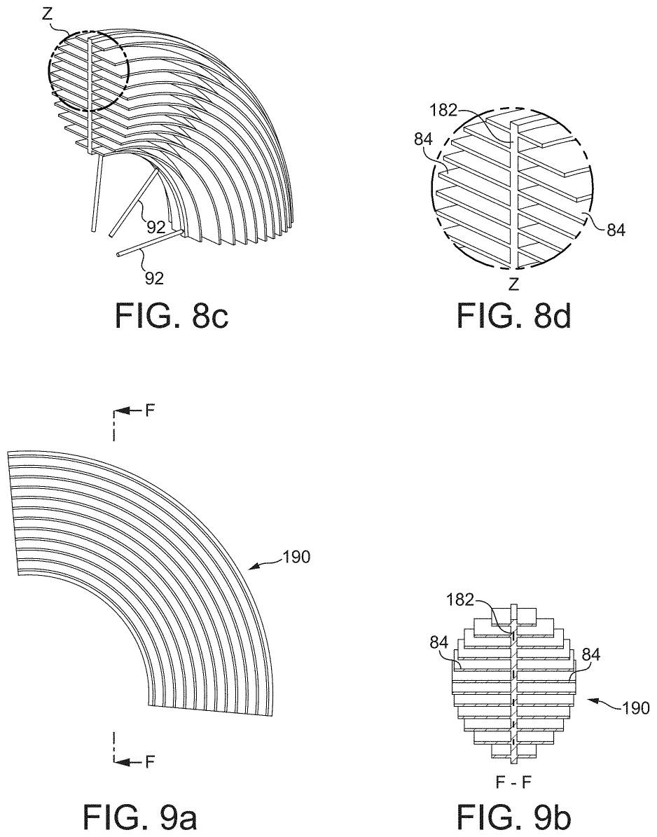

FIGS. 8a to 8d, 9a and 9b show another heater variation 90, 190. This heater is formed as a double sided heater 90. In this example the conductive track 90 is embedded in a flat ceramic plate 182 which has fins 84 attached to both sides. This eliminates the need for a bond between the two parts of the heater 80, 180 described with respect to FIGS. 6a to 6d and 7. The flat ceramic plate 182 can be fired and sintered fins 84 subsequently attached using a bonding paste or all the fins 84 can be attached to the flat ceramic plate 182 in the green state and the whole heater 90 fired to produce the final article.

FIGS. 9a and 9b show the heater 190 having a 110° bend or turn whereas FIGS. 8a to 8d show the heater having a 90° bend or turn.

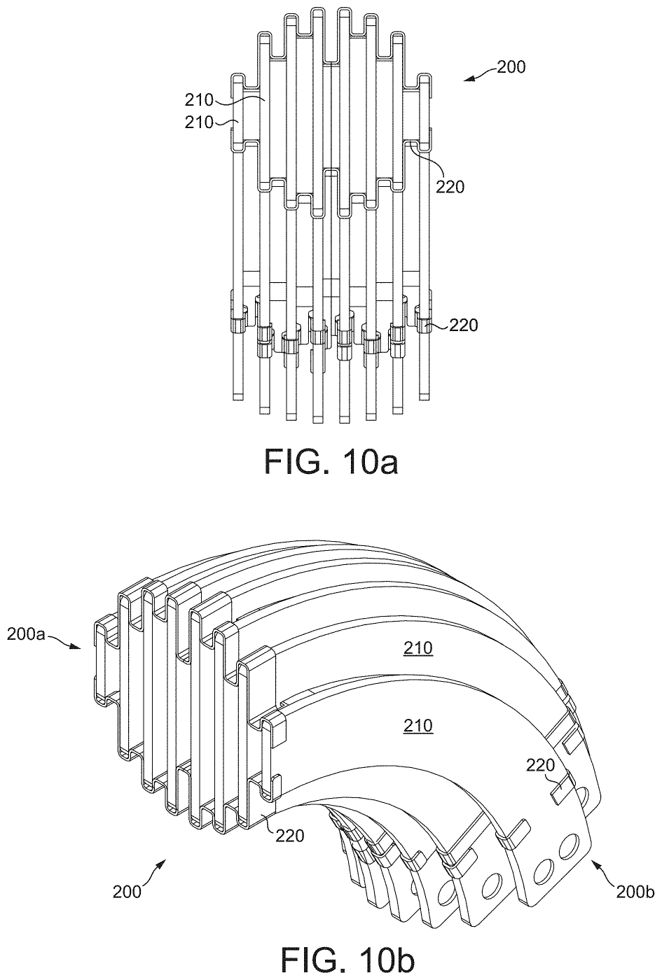

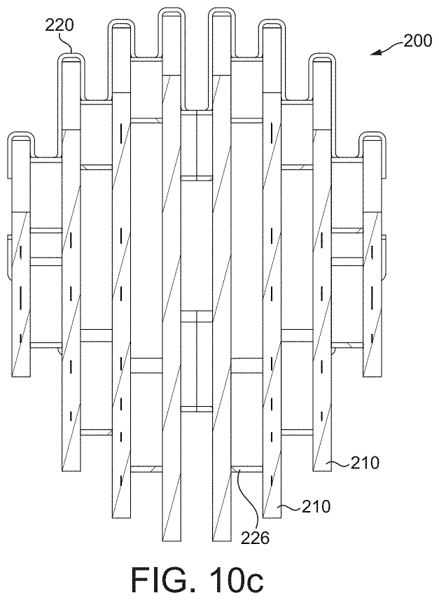

FIGS. 10a to 10c show another heater 200 variant. In this embodiment, a multitude of discrete flat ceramic plates 210 are used to provide the heat. As previously described, each of the discrete ceramic plates 210 includes a conductive track (not shown) and are held together with a scaffold formed from stamped metal sheets 220. The flat ceramic plates 210 are held at or near each end 200a and 200b of the heater 200 to maintain spacing between the flat ceramic plates 210 allowing fluid to flow between adjacent flat ceramic plates.

In all the examples shown, a three dimensional heater has been produced using a two dimensional heating element 88.

The examples showing fins 84 have an added benefit that the fins are used to dissipate heat from the heating element 88 and as they follow the curve of the heater 80, 90, 180, 190 the fins 84 assist in turning flow around the curve, reducing turbulence which reduces pressure losses through the heater as the fluid is turned from a first direction 120 to a second direction 130, 140 and also reduces the production of noise.

In the example without fins, as shown in FIGS. 10a to 10c, the plurality of heater elements 210 direct the flow of fluid flowing through the heater 200 by providing a longitudinal split through the fluid flow path. In this embodiment, as there are a plurality of heating elements 210 separate fins are not required for heat dissipation as instead of the heating element 80 having two surfaces available for thermal exchange with the fluid flow path, there are two times as many surfaces as there are heating elements.

Thus, thermal exchange from the heater to fluid flowing in the fluid flow path can be achieved by increasing the available surface of the heating element or by providing a cooling feature such as the fins which wick heat from the heating element towards the tips of the fins due to a thermal gradient, this heat is then exchanged with fluid that flows passed the fins which increases the thermal gradient causing more heat to be drawn along the fins.

In order to enable any angle of exit from the fluid outlet, the appliance is provided with a housing that extends beyond the heater. In FIG. 2, this piece of the housing 16 is straight and fluid flowing out of the heater 80 continues in the same direction. However, this piece of the housing does not need to be straight it could be curved to allow exit from a different angle or even be adjustable by a user to enable a range of different exit angles to be used.

The conductive track can be formed from two tracks as described, however one track can be used or more than two. Use of a single track may limit the temperatures setting available to the user whereas multiple tracks enable different wattage to be turned on and off giving more levels of temperature and more accurate control. Different wattage can be achieved by a number of different identical tracks or each track could be rated to a different number of watts. Also, although three connection points are shown, each track could have individual connection points or a different sharing arrangement could be used.

Suitable ceramic materials include aluminium nitride, aluminium oxide and silicon nitride.

According to various aspects, appliances have been described above as having a fluid flow and this has been used instead of air flow as it is known to use hair care appliances with refillable containers of serums or even water to hydrate hair as it is being styled. Indeed it may utilise a different combination of gases or gas and can include additives to improve performance of the appliance or the impact the appliance has on an object the output is directed at for example, hair and the styling of that hair.

The invention has been described in detail with respect to a hairdryer however, it is applicable to any appliance that draws in a fluid and directs the outflow of that fluid from the appliance.

According to various aspects, appliances can be used with or without a heater; the action of the outflow of fluid at high velocity has a drying effect.

According to various aspects, appliances have been described without discussion of any attachment such as a concentrating nozzle or a diffuser however, it would be feasible to use one of these known types of attachment in order to focus the exiting fluid or direct the fluid flow differently to how it exits the appliance without any such attachment.

The invention is not limited to the detailed description given above. Variations will be apparent to the person skilled in the art.

1. A hand held appliance comprising a fluid flow path extending between a fluid inlet and a fluid outlet and a ceramic heater within the fluid flow path wherein the fluid flow path is non-linear and the heater is non-linear.

2. The appliance of claim 1, further comprising a housing wherein the housing houses the heater and encloses the fluid flow path, and wherein the housing is curved.

3. The appliance of claim 2, wherein the heater is curved.

4. The appliance of claim 2, wherein the housing comprises a straight section and a curved section and the heater is housed within the curved section.

5. The appliance of claim 1, wherein the heater comprises at least one heating element comprising a flat ceramic plate and a conductive track.

6. The appliance of claim 5, wherein the heating element is arcuate.

7. The appliance of claim 6, wherein the heating element has a constant curvature.

8. The appliance of claim 6, wherein the heating element curves around an angle of 10° to 170°.

9. The appliance of claim 8, wherein the heating element curves around an angle of 80° to 120°.

10. The appliance of claim 1, wherein the heater comprises a heating element and a plurality of fins extending away from the heating element wherein, the plurality of fins dissipate heat from the heating element into the fluid flow path.

11. The appliance of claim 10, wherein the heating element is an arcuate flat plate and the plurality of fins extend away from the heating element and are also arcuate.

12. The appliance of claim 11, wherein each one of the plurality of fins follows the same angle of curvature as the heating element.

13. The appliance of claim 1, wherein the heater comprises a heating element and a plurality of fins extending away from the heating element and wherein the plurality of fins direct flow of fluid flowing within the heater.

14. The appliance of claim 13, wherein the plurality of fins comprise a channel extending between adjacent pairs of the plurality of fins and wherein each channel directs flow through the heater.

15. The appliance of claim 14, wherein each channel is defined by a surface of a pair of adjacent fins and a portion of a surface of the heating element and wherein, each channel dissipated thermal energy from the heating element into fluid flowing within the fluid flow path.

16. The appliance of claim 2, wherein the housing comprises a straight portion and a curved portion.

17. The appliance of claim 16, wherein within the straight portion, the housing houses a fan unit.

18. The appliance of claim 16, wherein within the straight portion the housing comprises a handle.

19. A hand held appliance comprising a housing, a fluid flow path extending between a fluid inlet and a fluid outlet and a ceramic heater within the fluid flow path, wherein the housing houses the heater and encloses the fluid flow path, and wherein the housing is curved and the heater is curved.

20. A housing enclosing a fluid flow path extending between a fluid inlet and a fluid outlet and housing a ceramic heater located within the fluid flow path, wherein the housing is curved and the heater is curved.

21. The appliance of claim 1, wherein the appliance is a hair care appliance.

22. The appliance of claim 1, wherein the appliance is a hairdryer.
